(19) United States
(12) Patent Application Publication
(10) Pub. No.: US 2024/0220626 A1
(43) Pub. Date: Jul. 4, 2024

(54) SECURE BOOT USING PARALLELIZATION

(71) Applicant: Intel Corporation, Santa Clara, CA (US)

(72) Inventors: Girisha Dengi, Bengaluru (IN); Karthika Murthy, Bangalore (IN); Santosh Male, Hyderabad (IN)

(73) Assignee: Intel Corporation, Santa Clara, CA (US)

(21) Appl. No.: 18/147,784

(22) Filed: Dec. 29, 2022

(51) Int. Cl. G06F 21/57

(52) U.S. Cl. CPC G06F 21/575

(57) ABSTRACT

An apparatus includes a basic input/output system (BIOS) comprising a boot read-only memory (Boot-ROM) to load a first stage boot loader (FSBL) into a random access memory (RAM), a processor comprising at least a first processing core and a second processing core, the processor to initialize, in the first processing core, a first set of system drivers, activate, the second processing core, and load, in the second processing core, a second stage boot loader and one or more operating system images into a main system memory.

### BACKGROUND

Modern computing devices may include general-purpose processor cores as well as a variety of hardware accelerators for offloading compute-intensive workloads or performing specialized tasks. Hardware accelerators may include, for example, one or more field-programmable gate arrays (FPGAs), which may include programmable digital logic resources that may be configured by the end user or system integrator. Hardware accelerators may also include one or more application-specific integrated circuits (ASICs). Hardware accelerators may be embodied as I/O devices that communicate with the processor core over an I/O interconnect.

A system on chip (SOC) is an integrated circuit that integrates all components of a computer or other electronic system. These components may include a central processing unit (CPU), memory, input/output (IO) ports and secondary storage, which are all included on a single substrate or microchip. Additionally, SOCs enable the integration of third party components via a standardized on-die interconnect protocol. However, the addition of such components may lead to security vulnerabilities.

In a typical embedded system, the system will boot up securely in multiple stages in series/sequential manner. In some examples, the first stage boot loader (FSBL) initializes the required system drivers and loads the second stage boot loader (SSBL) and operating system (OS) images from an external boot memory device such as to system main memory, then jump to system main memory and starts execution.

### BRIEF DESCRIPTION OF THE DRAWINGS

So that the manner in which the above recited features can be understood in detail, a more particular description, briefly summarized above, may be had by reference to embodiments, some of which are illustrated in the appended drawings. It is to be noted, however, that the appended drawings illustrate only typical embodiments and are therefore not to be considered limiting of its scope, for this disclosure may admit to other equally effective embodiments.

FIG. 1 is a schematic illustration of one embodiment of a computing device, according to examples.

FIG. 2 is a simplified block diagram of at least one embodiment of an environment of a computing device, according to examples.

FIG. 3 is a flow diagram illustrating operations in a method to implement secure boot using parallelization, according to embodiments.

FIG. 4 is a schematic illustration of various components of a platform configured to implement secure boot using parallelization, according to embodiments

FIG. 5 is a schematic illustration of an electronic device which may be adapted to implement secure boot using parallelization, according to embodiments.

### DETAILED DESCRIPTION

In the following description, numerous specific details are set forth to provide a more thorough understanding of various embodiments. However, it will be apparent to one of skill in the art that various embodiments may be practiced without one or more of these specific details. In other instances, well-known features have not been described in order to avoid obscuring any of the embodiments.

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Certain of the figures below detail example architectures and systems to implement embodiments of the above. In some embodiments, one or more hardware components and/or instructions described above are emulated as detailed below or implemented as software modules.

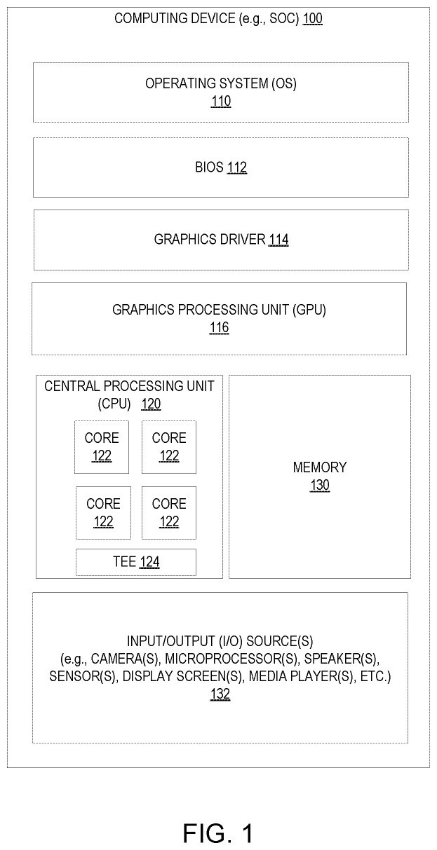

FIG. 1 is a schematic illustration of one embodiment of a computing device, according to examples. According to one embodiment, computing device 100 comprises a computer platform hosting an integrated circuit (“IC”), such as a system on a chip (“SoC” or “SOC”), integrating various hardware and/or software components of computing device 100 on a chip. Computing device 100 may include an operating system (OS) 110 serving as an interface between hardware and/or physical resources of computing device 100 and a user and a basic input/output system (BIOS) 112 which may be implemented as firmware and reside in a non-volatile section of memory 130. Further, computing device 100 may include a ny number and type of hardware and/or software components, such as (without limitation) graphics processing unit 116 (“GPU” or simply “graphics processor”), graphics driver 114 (also referred to as “GPU driver”, “graphics driver logic”, “driver logic”, user-mode driver (UMD), UMD, user-mode driver framework (UMDF), UMDF, or simply “driver”).

Computing device 100 may further comprise a central processing unit 120 (“CPU” or simply “application processor”) which, in turn, may comprise one or more processing cores 122. In the example depicted in FIG. 1 the CPU 122 comprises four (4) cores 122. CPU 120 may comprise one or more trusted execution environments (TEE) 124

Computing device 100 may further comprise network devices, drivers, or the like, as well as input/output (I/O) sources 132, such as touchscreens, touch panels, touch pads, virtual or regular keyboards, virtual or regular mice, ports, connectors, etc.

It is to be appreciated that a lesser or more equipped system than the example described above may be preferred for certain implementations. Therefore, the configuration of computing device 100 may vary from implementation to implementation depending upon numerous factors, such as price constraints, performance requirements, technological improvements, or other circumstances.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The terms “logic”, “module”, “component”, “engine”, and “mechanism” may include, by way of example, software or hardware and/or a combination thereof, such as firmware.

Embodiments may be implemented using one or more memory chips, controllers, CPUs (Central Processing Unit), microchips or integrated circuits interconnected using a motherboard, an application specific integrated circuit (ASIC), and/or a field programmable gate array (FPGA). The term “logic” may include, by way of example, software or hardware and/or combinations of software and hardware.

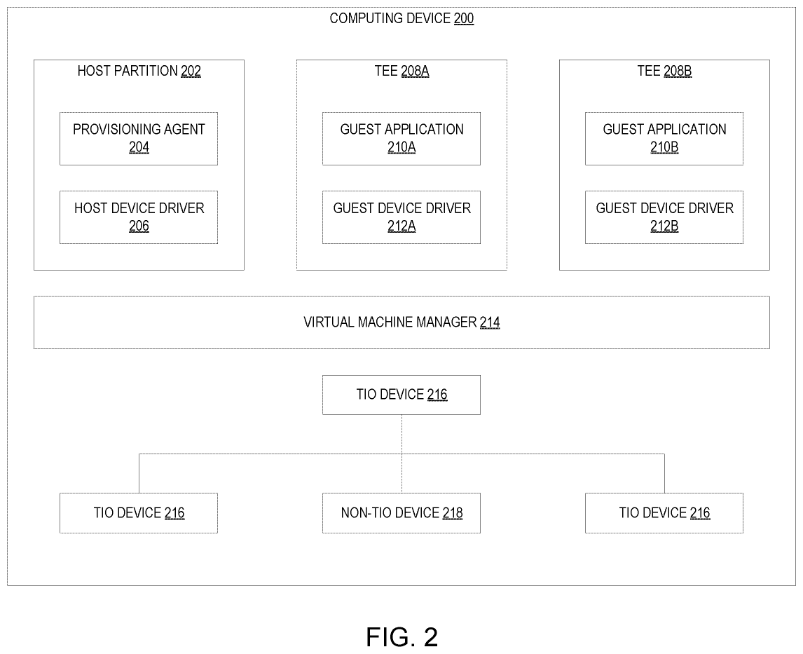

Referring now to FIG. 2, in an illustrative embodiment, the computing device 100 establishes an environment 200 during operation. The illustrative environment 200 includes a host partition 202 including a provisioning agent 204, multiple trusted execution environments (TEEs) 208A, 208B, a virtual machine monitor (VMM) 214, trusted I/O (TIO) devices 216, and non-trusted I/O devices 218. The various components of the environment 200 may be embodied as hardware, firmware, software, or a combination thereof. As such, in some embodiments, one or more of the components of the environment 200 may be embodied as circuitry or collection of electrical devices (e.g., provisioning agent circuitry 204. TEE circuitry 208, VMM circuitry 214, and/or TIO device circuitry 216). It should be appreciated that, in such embodiments, one or more of the provisioning agent circuitry 204, the TEE circuitry 208, the VMM circuitry 214, and/or the TIO device circuitry 216 may form a portion of the processor 120, the I/O subsystem 124, the accelerator 134, the peripheral devices 136, and/or other components of the computing device 100. Additionally, in some embodiments, one or more of the illustrative components may form a portion of another component and/or one or more of the illustrative components may be independent of one another.

The VMM 214 may be embodied as any virtual machine monitor, hypervisor, or other component that manages execution of one or more virtualized workloads on the computing device 100. The VMM 214 may manage workloads using hardware support of the processor 120, for example by executing in a privileged state such as VMX root, ring level −1, or another virtualization root mode. As described further below, the VMM 214 is responsible for managing hardware resources of the computing device 100, including the TIO devices 216. The VMM 214 is configured to launch the host partition 202 and/or the provisioning agent 204, and to launch the TEEs 208. The VMM 214 is configured to assign TIO devices 216 to particular TEEs 208. The VMM 214 may be configured to provide configuration commands to the TIO devices 216 as described below. The VMM 214 may be configured to enforce account permissions assigned to the provisioning agent 204. The VMM 214 may be configured to request the provisioning agent 204 to request that a TEE 208 releases an assigned TIO device 216.

The host partition 202 may be embodied as a root partition, host operating system, service virtual machine, or other partition of the computing device 100 that is trusted by the VMM 214 to access hardware of the computing device 100 (e.g., the TIO devices 216). As shown, the host partition 202 includes the provisioning agent 204 and one or more host device drivers 206. The provisioning agent 204 may be embodied as a trusted execution environment or other trusted agent of the computing device 100. The provisioning agent 204 executes as part of a user-mode service, daemon, or other process in a non-privileged execution mode (e.g., ring level 3 or other user mode). Illustratively, the provisioning agent 204 is a secure enclave established using Intel SGX technology. Each host device driver 206 may be embodied as an operating system driver, plugin, framework, or other system component that is configured to interact with and control the TIO devices 216. Each host device driver 206 may execute in kernel mode, ring level 0, or in another privileged execution mode. The host device drivers 206 have a communication channel to the provisioning agent 204 that may be used to service certain requests that originate from the TEE 208. For example, certain requests from paravirtualized guest device drivers 212 may be forwarded to the provisioning agent 204 for service (e.g., to provide attestation reports as described below). The provisioning agent 204 may also register with a plug-n-play (PnP) manager or other device hotplug manager of the host partition 202 to receive device change events, so the provisioning agent 204 can respond appropriately (e.g., by processing newly attached TIO devices 216).

The provisioning agent 204 is configured to securely command a TIO device 216 to enter a trusted I/O mode. Securely commanding the TIO device 216 may include protecting a configuration command with a provisioning key and providing the protected configuration command to the VMM 214. The VMM 214 provides the protected configuration command to the TIO device 216 as described above. The provisioning agent 204 is further configured to securely command the TIO device 216 to set a global lock on configuration registers and to receive in response configuration data indicative of the configuration registers of the TIO device 216. The provisioning agent 204 is further configured to securely command the TIO device 216 to atomically release the global lock and set a fine-grained lock on one or more of the configuration registers. The provisioning agent 204 is further configured to provide the configuration data to a TEE 208 in response setting the fine-grained lock.

The provisioning agent 204 may be further configured to perform an attestation protocol with the TIO device 216 to generate a device attestation report, verify the device attestation report, and securely provision the I/O device with the provisioning key in response to verifying the device attestation report. The provisioning agent 204 may be further configured to sign the device attestation report with a private key to generate a signed device attestation report, to include the signed device attestation report and a trusted agent attestation report in an attestation report; and to provide the combined attestation report to the TEE 208.

The provisioning agent 204 may be further configured to determine whether the TEE 208 has released the TIO device 216 and, in response, to securely command the TIO device 216 to release the fine-grained lock. The provisioning agent 204 may be further configured to determine whether any other trusted execution environment is using the TIO device 216 and securely command the TIO device 216 to exit the trusted I/O mode if no other TEE 208 is using the TIO device 216. The provisioning agent 204 may be further configured to receive a request to reclaim the I/O device from the VMM 214 and, in response, to request the TEE 208 to release the TIO device 216.

Each TIO device 216 may be embodied as an I/O device capable of secure configuration and trusted I/O operations as described further below. For example, the TIO devices 216 may include one or more data storage devices 130, network interface controllers 132, accelerators 134, peripheral devices 136, or other endpoint devices and/or one or more I/O switches 138 or other switches that connect endpoint devices to a root complex of the host. Each TIO device 216 is configured to receive a configuration command and to determine whether the configuration command is restricted to the provisioning agent 204. Configuration commands restricted to the provisioning agent 204 may include commands to enter or exit the trusted I/O mode, or commands to lock or unlock a configuration register. Each TIO device 216 is further configured to determine, for each configuration command restricted to the provisioning agent 204, whether the configuration command is received from the provisioning agent 204 and, if so, to process the configuration command and, if not, to reject the configuration command. The TIO device 216 may determine whether the configuration command is received from the provisioning agent 204 by determining whether the configuration command is protected by the provisioning key, as described above. Each TIO device 216 is further configured to determine, for each configuration command that is not restricted to the provisioning agent 204, whether the TIO device 216 is in the trusted I/O mode. If not the TIO mode, the TIO device 216 is configured to process the configuration command. If in the TIO mode, the TIO device 216 is further configured to determine whether a configuration register associated with the configuration command is locked and, if so, whether the configuration command is received from the provisioning agent 204. The TIO device 216 is configured to reject the configuration command if the configuration register is locked and the configuration command is not received from the provisioning agent 204. The TIO device 216 is configured to process the configuration command if the configuration register is not locked, or if the configuration register is locked and the configuration command is received from the provisioning agent 204.

As shown in FIG. 2, the TIO devices 216 may be included in a device tree such as a PCI Express (PCIe) device tree. The device tree may also include one or more non-TIO devices 218. Each non-TIO device 218 may be embodied as an I/O device (e.g., a data storage device 130, network interface controller 132, accelerator 134, peripheral device 136, and/or other endpoint, switch, or bridge device) that is not capable of secure configuration and trusted I/O operations.

Each of the TEEs 208 may be embodied as a trust domain, virtual machine, virtual network function (VNF), guest operating system, or other trusted environment of the computing device 100. Each TEE 208 is isolated or otherwise protected from the VMM 214, host partition 202, and other TEEs 208 with hardware support of the computing device 100. Thus, the VMM 214 is outside of the trusted computing base (TCB) of each TEE 208. Illustratively, each TEE 208 is a trust domain (TD) that is protected with the MKTME 126. As shown, each TEE 208 may include a guest application 210 and one or more guest device drivers 212. The guest device drivers 212 may access a paravirtualized application programming interface (API) or other interface supplied by a host device driver 206, the host partition 202, and/or the VMM 214. Each TEE 208 is configured to verify the attestation report received from the provisioning agent 204 and, in response, to request the provisioning agent 204 to prepare an assigned TIO device 216 for trusted I/O.

In a typical embedded system, the system will boot up securely in multiple stages in series/sequential manner. In some examples, the first stage boot loader (FSBL) initializes the required system drivers and loads the second stage boot loader (SSBL) and operating system (OS) images from an external boot memory device such as to system main memory, then jump to system main memory and starts execution. This may introduce undue latency in the boot process.

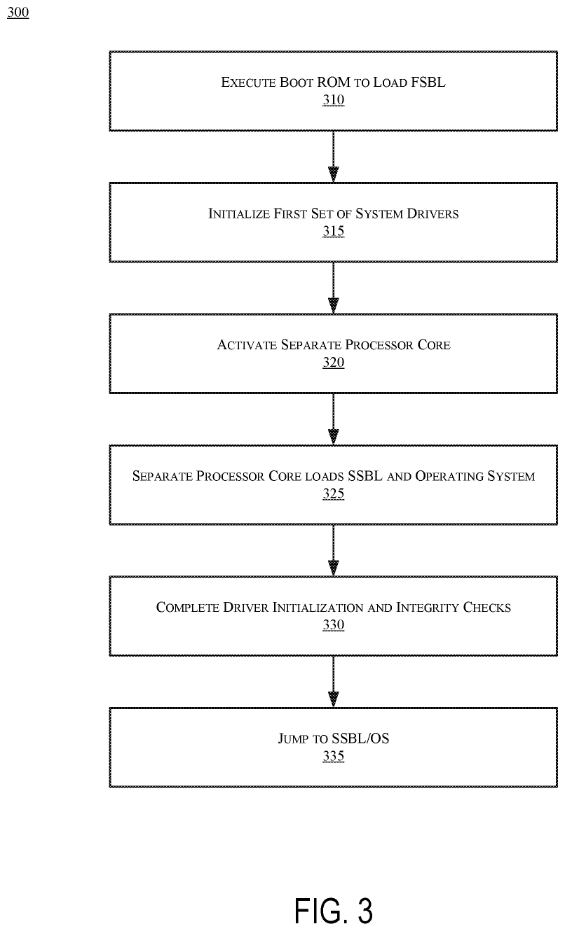

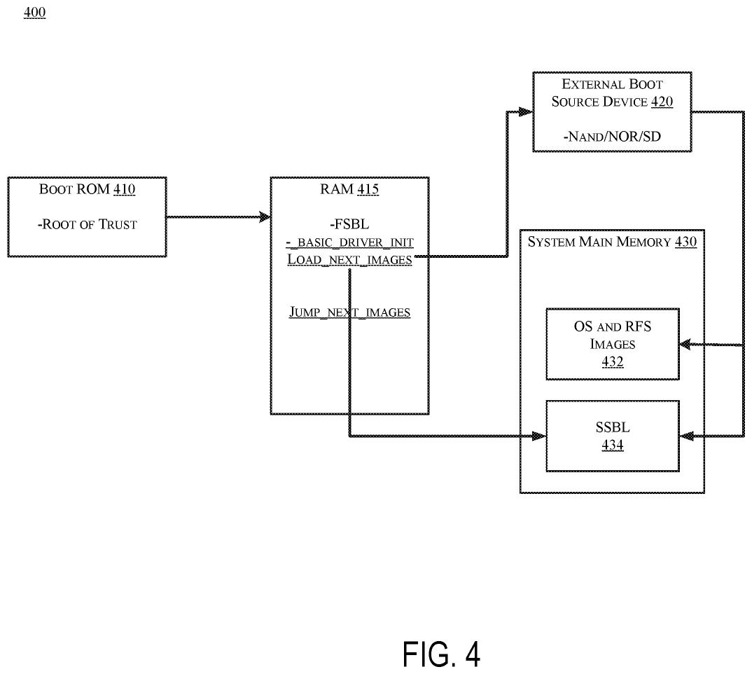

To address these and other issues, subject matter described herein provides technology and methods to perform secure boot using parallelization. In some examples, a first stage boot loader is loaded into a first memory. The first stage boot loader delegates the second stage boot loader process to a separate processor core, which loads the second stage boot loader and operating system images in parallel with the boot processes performed by the first stage boot loader. Once the first stage boot loader completes is processes, it jumps to the second stage boot loader and then the operating system image. Allowing these processes to execute in parallel reduces the latency inherent in the boot process. Details of an example process will be described with reference to FIGS. 3-4.

FIG. 3 is a flow diagram illustrating operations in a method to implement secure boot using parallelization, according to embodiments, and FIG. 4 is a schematic illustration of various components of a platform 400 configured to implement secure boot using parallelization, according to embodiments. In some examples, the operations depicted in FIG. 3 may be implemented by BIOS 112 and one or more cores 122 of the computing device 100.

Referring to FIG. 3 and FIG. 4, at operation 310 the boot ROM 410 is executed to load the first stage boot loader (FSBL) into the random access memory (RAM) 415. In some examples the boot ROM acts as a primary Root of Trust (RoT). At operation 315 the first stage boot loader initializes a minimum set of system drivers and at operation 320 it activates a separate processing core. In some examples the separate processing core is delegated the tasks of loading, at operation 325, the operating system image(s) 432 and the second stage boot loader (SSBL) 434 into the main system memory 430. This may be performed in parallel with additional initialization and verification operations implemented by the first stage boot loader.

At operation 330 the first stage boot loader completes the driver initialization process and any associated integrity checks, whereupon it jumps to the second stage boot loader to finish loading the operating system and any remote file sharing images (operation 335).

Thus, the operations of FIG. 3 and the structure depicted in FIG. 4 permit a multi-stage boot loading process to be performed in parallel, which reduces latency in the boot process.

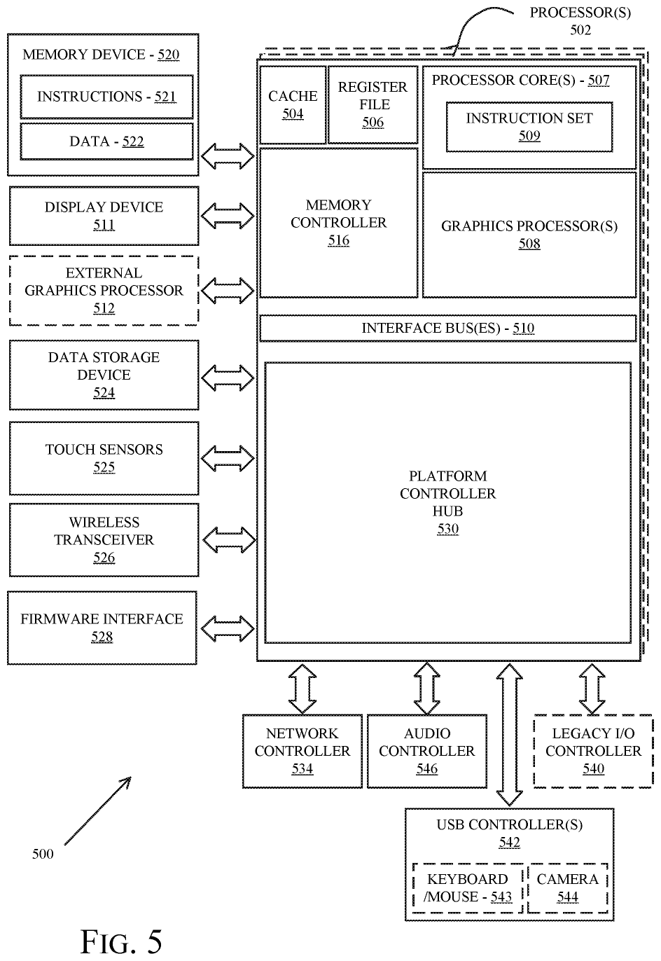

FIG. 5 is a schematic illustration of an electronic device which may be adapted to implement secure boot using parallelization, according to embodiments. In various embodiments, the computing architecture 500 may comprise or be implemented as part of an electronic device. In some embodiments, the computing architecture 500 may be representative, for example of a computer system that implements one or more components of the operating environments described above. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 500 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 500.

As shown in FIG. 5, the computing architecture 500 includes one or more processors 502 and one or more graphics processors 508, and may be a single processor desktop system, a multiprocessor workstation system, or a server system having a large number of processors 502 or processor cores 507. In on embodiment, the system 500 is a processing platform incorporated within a system-on-a-chip (SoC or SOC) integrated circuit for use in mobile, handheld, or embedded devices.

An embodiment of system 500 can include, or be incorporated within a server-based gaming platform, a game console, including a game and media console, a mobile gaming console, a handheld game console, or an online game console. In some embodiments system 500 is a mobile phone, smart phone, tablet computing device or mobile Internet device. Data processing system 500 can also include, couple with, or be integrated within a wearable device, such as a smart watch wearable device, smart eyewear device, augmented reality device, or virtual reality device. In some embodiments, data processing system 500 is a television or set top box device having one or more processors 502 and a graphical interface generated by one or more graphics processors 508.

In some embodiments, the one or more processors 502 each include one or more processor cores 507 to process instructions which, when executed, perform operations for system and user software. In some embodiments, each of the one or more processor cores 507 is configured to process a specific instruction set 509. In some embodiments, instruction set 509 may facilitate Complex Instruction Set Computing (CISC), Reduced Instruction Set Computing (RISC), or computing via a Very Long Instruction Word (VLIW). Multiple processor cores 507 may each process a different instruction set 509, which may include instructions to facilitate the emulation of other instruction sets. Processor core 507 may also include other processing devices, such a Digital Signal Processor (DSP).

In some embodiments, the processor 502 includes cache memory 504. Depending on the architecture, the processor 502 can have a single internal cache or multiple levels of internal cache. In some embodiments, the cache memory is shared among various components of the processor 502. In some embodiments, the processor 502 also uses an external cache (e.g., a Level-3 (L3) cache or Last Level Cache (LLC)) (not shown), which may be shared among processor cores 507 using known cache coherency techniques. A register file 506 is additionally included in processor 502 which may include different types of registers for storing different types of data (e.g., integer registers, floating point registers, status registers, and an instruction pointer register). Some registers may be general-purpose registers, while other registers may be specific to the design of the processor 502.

In some embodiments, one or more processor(s) 502 are coupled with one or more interface bus(es) 510 to transmit communication signals such as address, data, or control signals between processor 502 and other components in the system. The interface bus 510, in one embodiment, can be a processor bus, such as a version of the Direct Media Interface (DMI) bus. However, processor busses are not limited to the DMI bus, and may include one or more Peripheral Component Interconnect buses (e.g., PCI, PCI Express), memory busses, or other types of interface busses. In one embodiment the processor(s) 502 include an integrated memory controller 516 and a platform controller hub 530. The memory controller 516 facilitates communication between a memory device and other components of the system 500, while the platform controller hub (PCH) 530 provides connections to I/O devices via a local I/O bus.

Memory device 520 can be a dynamic random-access memory (DRAM) device, a static random-access memory (SRAM) device, flash memory device, phase-change memory device, or some other memory device having suitable performance to serve as process memory. In one embodiment the memory device 520 can operate as system memory for the system 500, to store data 522 and instructions 521 for use when the one or more processors 502 executes an application or process. Memory controller hub 516 also couples with an optional external graphics processor 512, which may communicate with the one or more graphics processors 508 in processors 502 to perform graphics and media operations. In some embodiments a display device 511 can connect to the processor(s) 502. The display device 511 can be one or more of an internal display device, as in a mobile electronic device or a laptop device or an external display device attached via a display interface (e.g., DisplayPort, etc.). In one embodiment the display device 511 can be a head mounted display (HMD) such as a stereoscopic display device for use in virtual reality (VR) applications or augmented reality (AR) applications.

In some embodiments the platform controller hub 530 enables peripherals to connect to memory device 520 and processor 502 via a high-speed I/O bus. The I/O peripherals include, but are not limited to, an audio controller 546, a network controller 534, a firmware interface 528, a wireless transceiver 526, touch sensors 525, a data storage device 524 (e.g., hard disk drive, flash memory, etc.). The data storage device 524 can connect via a storage interface (e.g., SATA) or via a peripheral bus, such as a Peripheral Component Interconnect bus (e.g., PCI, PCI Express). The touch sensors 525 can include touch screen sensors, pressure sensors, or fingerprint sensors. The wireless transceiver 526 can be a Wi-Fi transceiver, a Bluetooth transceiver, or a mobile network transceiver such as a 3G, 4G, or Long Term Evolution (LTE) transceiver. The firmware interface 528 enables communication with system firmware, and can be, for example, a unified extensible firmware interface (UEFI). The network controller 534 can enable a network connection to a wired network. In some embodiments, a high-performance network controller (not shown) couples with the interface bus 510. The audio controller 546, in one embodiment, is a multi-channel high definition audio controller. In one embodiment the system 500 includes an optional legacy I/O controller 540 for coupling legacy (e.g., Personal System 2 (PS/2)) devices to the system. The platform controller hub 530 can also connect to one or more Universal Serial Bus (USB) controllers 542 connect input devices, such as keyboard and mouse 543 combinations, a camera 544, or other USB input devices.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMS, EPROMS (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

Throughout the document, term “user” may be interchangeably referred to as “viewer”, “observer”, “speaker”, “person”, “individual”, “end-user”, and/or the like. It is to be noted that throughout this document, terms like “graphics domain” may be referenced interchangeably with “graphics processing unit”, “graphics processor”, or simply “GPU” and similarly, “CPU domain” or “host domain” may be referenced interchangeably with “computer processing unit”, “application processor”, or simply “CPU”.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

In various implementations, the computing device may be a laptop, a netbook, a notebook, an ultrabook, a smartphone, a tablet, a personal digital assistant (PDA), an ultra mobile PC, a mobile phone, a desktop computer, a server, a set-top box, an entertainment control unit, a digital camera, a portable music player, or a digital video recorder. The computing device may be fixed, portable, or wearable. In further implementations, the computing device may be any other electronic device that processes data or records data for processing elsewhere.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMS, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Some embodiments pertain to Example 1 that includes an apparatus comprising a basic input/output system (BIOS) comprising a boot read-only memory (Boot-ROM) to load a first stage boot loader (FSBL) into a random access memory (RAM); and a processor comprising at least a first processing core and a second processing core, the processor to initialize, in the first processing core, a first set of system drivers; activate, the second processing core; and load, in the second processing core, a second stage boot loader and one or more operating system images into a main system memory.

Example 2 includes the subject matter of Example 1, the BIOS to establish a hardware root of trust for a computing device.

Example 3 includes the subject matter of Examples 1 and 2, the first processing core to verify the first stage boot loader (FSBL) module.

Example 4 includes the subject matter of Examples 1-3, the first processing core to verify the second stage boot loader (SSBL) module.

Example 5 includes the subject matter of Examples 1-4, the first processing core to verify the at least one operating system image.

Example 6 includes the subject matter of Examples 1-5, the first processing core to authorize the second stage boot loader (SSBL) to complete a boot process.

Example 7 includes the subject matter of Examples 1-6, wherein the second stage boot loader (SSBL) is to complete the boot process for the computing device.

Some embodiments pertain to Example 8 that includes a method comprising loading, in a basic input/output system (BIOS) comprising a boot read-only memory (Boot-ROM), a first stage boot loader (FSBL) into a random access memory (RAM); in a first processing core of a processor initializing a first set of system drivers; activating a second processing core of the processor; and in the second processing core of the processor loading a second stage boot loader and one or more operating system images into a main system memory.

Example 9 includes the subject matter of Example 8, further comprising establishing, in the BIOS, a hardware root of trust for a computing device.

Example 10 includes the subject matter of Examples 8 and 9, further comprising verifying, in the first processing core, the second stage boot loader (SSBL) module.

Example 11 includes the subject matter of Examples 8-10, further comprising verifying, in the first processing core, the second stage boot loader (SSBL) module.

Example 12 includes the subject matter of Examples 8-11, further comprising verifying, in the first processing core, the at least one operating system image.

Example 13 includes the subject matter of Examples 8-12, further comprising authorizing, in the first processing core, the second stage boot loader (SSBL) to complete a boot process.

Example 14 includes the subject matter of Examples 8-13, further comprising completing, in the second stage boot loader (SSBL) the boot process for the computing device.

Some embodiments pertain to Example 15, that includes at least one non-transitory computer readable medium having instructions stored thereon, which when executed by a processor, cause the processor to perform operations comprising loading, in a basic input/output system (BIOS) comprising a boot read-only memory (Boot-ROM), a first stage boot loader (FSBL) into a random access memory (RAM); in a first processing core of a processor initializing a first set of system drivers; activating a second processing core of the processor; and in the second processing core of the processor loading a second stage boot loader and one or more operating system images into a main system memory.

Example 16 includes the subject matter of Example 15, further comprising instruction which, when executed by processor, cause the BIOS to establish a hardware root of trust for a computing device.

Example 17 includes the subject matter of Examples 15 and 16, further comprising instruction which, when executed by processor, cause the processor to perform operations comprising verifying, in the first processing core, the second stage boot loader (SSBL) module.

Example 18 includes the subject matter of Examples 15-17, further comprising instruction which, when executed by processor, cause the processor to perform operations comprising verifying, in the first processing core, the second stage boot loader (SSBL) module.

Example 19 includes the subject matter of Examples 15-18, further comprising instruction which, when executed by processor cause the processor to perform operations comprising verifying, in the first processing core, the at least one operating system image,

Example 20 includes the subject matter of Examples 15-19, further comprising instruction which, when executed by processor, cause the processor to perform operations comprising authorizing, in the first processing core, the second stage boot loader (SSBL) to complete a boot process.

Example 21 includes the subject matter of Examples 15-20, further comprising instruction which, when executed by processor, cause the processor to perform operations comprising completing, in the second stage boot loader (SSBL) the boot process for the computing device.

The details above have been provided with reference to specific embodiments. Persons skilled in the art, however, will understand that various modifications and changes may be made thereto without departing from the broader spirit and scope of any of the embodiments as set forth in the appended claims. The foregoing description and drawings are, accordingly, to be regarded in an illustrative rather than a restrictive sense.

What is claimed is:

1. An apparatus comprising:
a basic input/output system (BIOS) comprising a boot read-only memory (Boot-ROM) to load a first stage boot loader (FSBL) into a random access memory (RAM); and
a processor comprising at least a first processing core and a second processing core, the processor to:
initialize, in the first processing core, a first set of system drivers;
activate the second processing core; and
load, in the second processing core, a second stage boot loader and one or more operating system images into a main system memory.

2. The apparatus of claim 1, the BIOS to:
establish a hardware root of trust for a computing device.

3. The apparatus of claim 2, the first processing core to:
verify the first stage boot loader (FSBL) module.

4. The apparatus of claim 3, the first processing core to:
verify the second stage boot loader (SSBL) module.

5. The apparatus of claim 4, the first processing core to:
verify the at least one operating system image.

6. The apparatus of claim 5, the first processing core to:
authorize the second stage boot loader (SSBL) to complete a boot process.

7. The apparatus of claim 6, wherein the second stage boot loader (SSBL) is to:
complete the boot process for the computing device.

8. A processor-implemented method, comprising:
loading, in a basic input/output system (BIOS) comprising a boot read-only memory (Boot-ROM), a first stage boot loader (FSBL) into a random access memory (RAM);
in a first processing core of a processor:
initializing a first set of system drivers;
activating a second processing core of the processor; and
in the second processing core of the processor:
loading a second stage boot loader and one or more operating system images into a main system memory.

9. The method of claim 8, further comprising:
establishing, in the BIOS, a hardware root of trust for a computing device.

10. The method of claim 9, further comprising:
verifying, in the first processing core, the second stage boot loader (SSBL) module.

11. The method of claim 10, further comprising:
verifying, in the first processing core, the second stage boot loader (SSBL) module.

12. The method of claim 11, further comprising:
verifying, in the first processing core, the at least one operating system image.

13. The method of claim 12, further comprising:
authorizing, in the first processing core, the second stage boot loader (SSBL) to complete a boot process.

14. The method of claim 13, further comprising:
completing, in the second stage boot loader (SSBL) the boot process for the computing device.

15. At least one non-transitory computer readable medium having instructions stored thereon, which when executed by a processor, cause the processor to execute instructions to perform operations, comprising:
loading, in a basic input/output system (BIOS) comprising a boot read-only memory (Boot-ROM), a first stage boot loader (FSBL) into a random access memory (RAM);
in a first processing core of a processor:
initializing a first set of system drivers;
activating a second processing core of the processor; and
in the second processing core of the processor:
loading a second stage boot loader and one or more operating system images into a main system memory.

16. The computer readable medium of claim 15, further comprising instruction which, when executed by processor, cause the processor to perform operations comprising:
establishing, in the BIOS, a hardware root of trust for a computing device.

17. The computer readable medium of claim 16, further comprising instruction which, when executed by processor, cause the processor to perform operations comprising:
verifying, in the first processing core, the second stage boot loader (SSBL) module.

18. The computer readable medium of claim 17, further comprising instruction which, when executed by processor, cause the processor to perform operations comprising:
verifying, in the first processing core, the second stage boot loader (SSBL) module.

19. The computer readable medium of claim 18, further comprising instruction which, when executed by processor, cause the processor to perform operations comprising:
verifying, in the first processing core, the at least one operating system image.

20. The computer readable medium of claim 19, further comprising instruction which, when executed by processor, cause the processor to perform operations comprising:
authorizing, in the first processing core, the second stage boot loader (SSBL) to complete a boot process.

21. The computer readable medium of claim 20, wherein the at least one agent is to perform operations comprising:
completing, in the second stage boot loader (SSBL) the boot process for the computing device.
